(19) United States
(12) Patent Application Publication
(10) Pub. No.: US 2006/0032806 A1
(43) Pub. Date: Feb. 16, 2006

(54) Apparatus to filter water

(76) Inventor: Mark Allan Parker, Clovis, CA (US)

Correspondence Address: Mark Parker, 3136 Fairfax Ave., Clovis, CA, 93612, US

(21) Appl. No.: 10/919,176

(22) Filed: Aug. 16, 2004

(51) Int. Cl. B01D 35/30

(52) U.S. Cl. 210/232; 210/435

(57) ABSTRACT

An apparatus to filter water with a Filter that slides in or out of housing easily, Filter has different size inlet and outlet nipples to prevent incorrect installation, The cam action locking levers easily pull filter into housing when pushed downward and easily remove filter when cam action levers are pushed upward, and rubber o-rings on inlet and outlet nipples of filter fit snuggly into housing which prevents leakage and assures all water must pass through filter media.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of filtering water and more specifically to an apparatus to filter water. People are becoming more concerned with the quality of water that is piped to their homes, and many are having filter units installed to filter out debris, sand, silt, rust, scale, or to improve taste and odor. Many of these people come to find that a portion of their problems are still existing and that is because a sizable contributor of the scale, rust, taste and odor problems come from their own plumbing contained within the perimeter of the house itself. These debris can cause premature failure of plumbing fixtures, which could cause plumbing fixtures or valves to plug giving low or no water output. Some cases debris can become stuck in a valve and prevent the valve from closing, this can become a very costly problem, because if a valve in a toilet, dishwasher,or another type of water using device is stuck, it could cause costly water damage or flooding problems. Unfortunately filtering the water supplies to sink mounted faucets, dishwashers, clothes washing machines,toilets and many other plumbing fixtures and related devices have not been pursued heavily enough to cause new innovations

Searching prior patents, and technology there are only two that seem to be related to the claims of the inline water filter. Patents related are U.S. Pat. No. 6,494,325 inventor Mizzahi Dec. 17, 2002 in this invention is described a toilet water line water filer using a type of screen mesh to prevent debris from entering the toilet fill valve.

U.S. Pat. No. 5,397,462 inventors Higashijima,Fukuoka, Fumiya, Kitayama, Kasuga, Shinji, Suematsu, Fukuoka, all from Japan Mar. 14, 1995 this invention is a round filter with inlet on one end and outlet on other, they do mention using it for water supply to kitchen faucet

All present filters seem to focus on the same space wasting cylindrical design,or use sophisticated designs which would be costly to both the manufacture and the consumer alike.

### BRIEF SUMMARY OF THE INVENTION

The primary object of the invention is To provide an efficient practical apparatus of simple construction which will effectively filter impurities, debris, also improve taste and odor using correct media such as activated carbon.

Another object of the invention is To provide an efficient practical apparatus of simple construction which is very easy to use due to the slide in and out design.

Another object of the invention is To provide an improved filter housing that does not rely on round bulky space wasting filters.

A further object of the invention is To provide an improved space saving rectangular filter and housing.

Yet another object of the invention is To provide a means to filter water to individual fixtures and appliances that have been previously overlooked such as but not limited to sink mounted faucets, toilets, dishwashers and more.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus to filter water comprising: Filter slides in or out of housing easily, Filter has different size inlet and outlet nipples to prevent incorrect installation, The cam action locking levers easily pull filter into housing when pushed downward and easily remove filter when cam action levers are pushed upward, and rubber o-rings on inlet and outlet nipples of filter fit snuggly into housing which prevents leakage and assures all water must pass through filter media.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 shows the angle stops and supply lines for a lav faucet.

FIG. 2 shows the inline filters attached to a lav faucet.

FIG. 3 shows the o-rings for a water-tight filter to housing connection.

FIG. 4 shows the “Water In” from source.

FIG. 5 shows the filter housing.

FIG. 6 shows the filter locking lever.

FIG. 7 shows both siders are threaded for fixture supply line connection.

FIG. 8 shows the “Water Out” to fixture.

FIG. 9 shows how the filter slides up into the housing.

FIG. 10 shows the inlet

FIG. 11 shows the filter locking levers

FIG. 12 shows the outlet

FIG. 13 shows the filter housing.

FIG. 14 shows the tabs for the filter locing levers to grab onto.

FIG. 15 Shows the filter locking levers.

FIG. 16 Shows the water outlet nipple.

FIG. 17 Shows the filter.

FIG. 18 shows the locking levers

FIG. 19 shows the levers grab pegs on filter sides to lock in place.

FIG. 20 Shows the locing lever has a slot for filter peg to lock filter in place and cam action automaticaly removes filter for replacement.

FIG. 21 shows the center shaft.

FIG. 22 shows the enlarged side-view of the locing lever.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

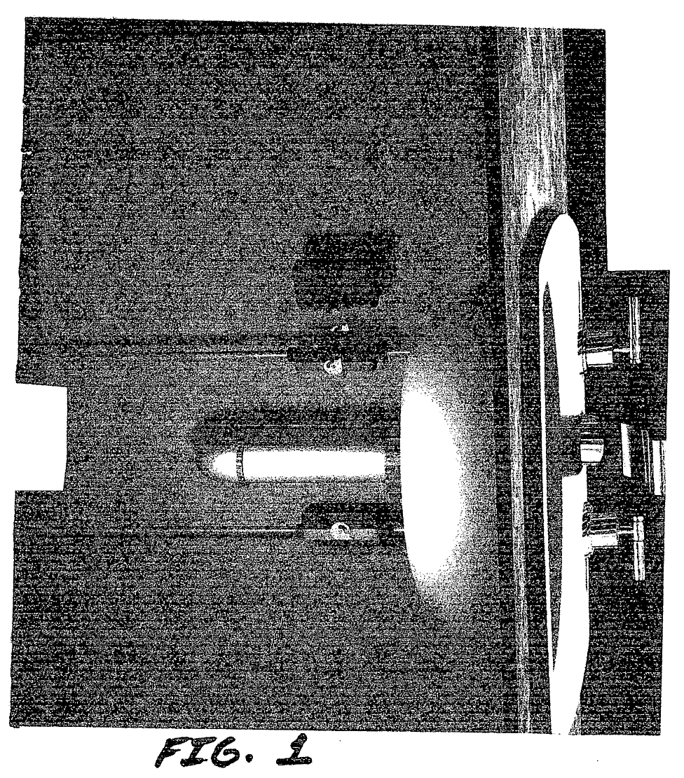

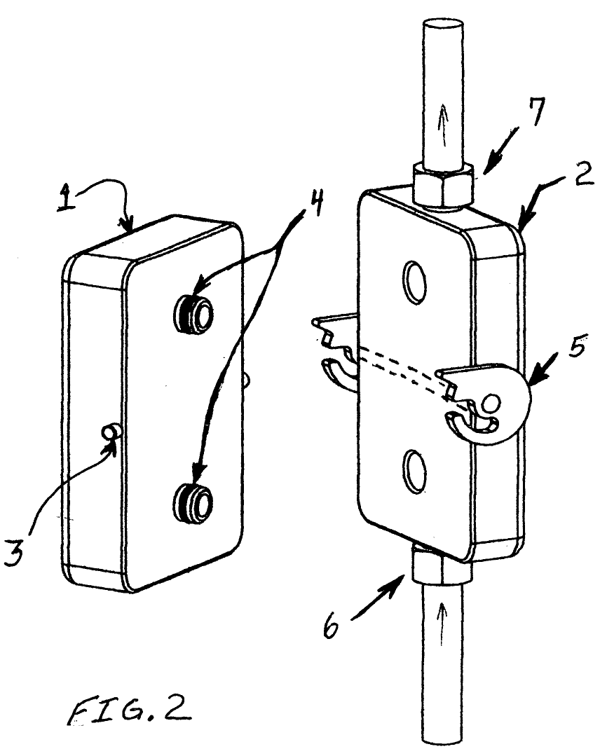

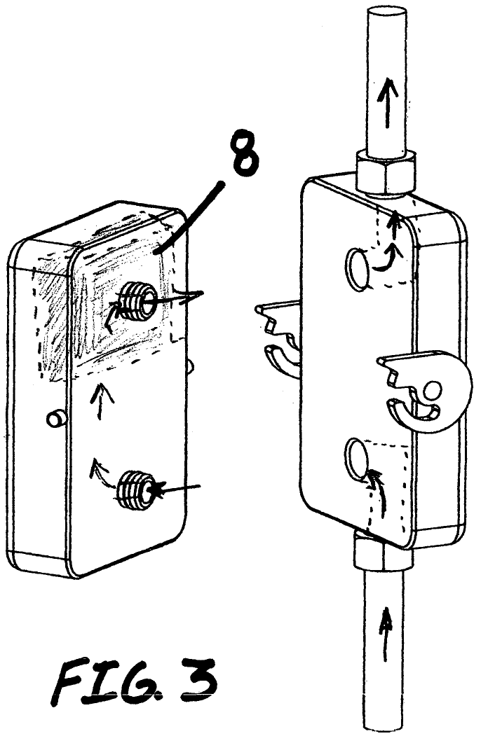

FIGS. 10, 11, 12 show the top view of this design this square shape housing has a shaft that goes through the middle of the housing, FIG. 11 to connect the tow filter locing levers which work the slotted cam action, FIG. 19. This lever is designed to pull up and loc the filter, FIG. 17, into the correct position and release the filter, FIG. 17, for easy removal when replacement is needed. A slot on the lever, FIG. 20, will push the tab on the filter, FIG. 17, downward when pushing the filter, FIG. 17, in the opposite direction allowing the o-rings, FIG. 3, on the nipple of the filter, FIG. 17, to slide snuggly into the filter housing, FIG. 13, for a water-tight connection and positive filtration. The slide “in-and-out” design, FIG. 9, ith the cam action locing levers, FIGS. 18, 19, 20, 21, 22, will make this filter, FIG. 17, very easy to install and remove. These filters, FIG. 17, are to be used in-line between the angle stops (water valves) and the faucet, FIGS. 1 & 2. The filter, FIG. 17, will help reduce san, debris, etc., from both hot and cold sides of the faucet and provide cleaner water for both hot and cold sides of the faucet. The filter, FIG. 17, can be made with many different medias such as for taste, odor, etc., for each individuals needs.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus to filter water comprising:
A. Filter unit is designed to easily filter water supply to indoor fixtures such as but not limited to water closets (toilets), deck mounted faucets, clothes washing machines, dishwashing machines, etc.;
B. Filter slides in or out of housing easily;
C. Filter has different size inlet and outlet nipples to prevent incorrect installation;
D. Housing can easily be fitted with automatic shutoff if desired;
E. The cam action locking levers easily pull filter into housing when pushed downward and easily remove filter when cam action levers are pushed upward; and
F. Rubber o-rings on inlet and outlet nipples of filter fit snuggly into housing which prevents leakage and assures all water must pass through filter media.
